(19) United States
(12) Patent Application Publication
(10) Pub. No.: US 2019/0283131 A1
(43) Pub. Date: Sep. 19, 2019

(54) METHOD FOR MANUFACTURING THREE-DIMENSIONAL OBJECT

(71) Applicant: Seiko Epson Corporation, Tokyo (JP)

(72) Inventors: Yasutoshi HIDESHIMA, Matsumoto (JP); Naoko SHIMA, Shiojiri (JP)

(21) Appl. No.: 16/351,607

(22) Filed: Mar. 13, 2019

(30) Foreign Application Priority Data
Mar. 14, 2018 (JP) 2018-046763

(51) Int. Cl. B22F 3/00; B29C 64/165; B29C 64/35; B33Y 10/00; B33Y 40/00

(52) U.S. Cl. CPC B22F 3/008; B29C 64/165; B33Y 40/00; B33Y 10/00; B29C 64/35

(57) ABSTRACT

A method for manufacturing a three-dimensional object includes a layer-forming step (Step S150) of forming layers using a flowable composition containing a constituent material powder and binder for forming a three-dimensional object; a degreasing step (Step S170) of removing the binder from a multilayer body, formed by stacking the layers, for the three-dimensional object; and a sintering step (Step S180) of sintering the constituent material powder by heating the multilayer body free from the binder. In the layer-forming step, channels leading to a surface of the multilayer body are formed such that gas, derived from the binder, generated in the degreasing step can flow through the channels.

This application claims priority under 35 U.S.C. § 119 to Japanese Patent Application No. 2018-046763 filed on Mar. 14, 2018, the entire disclosure of which is expressly incorporated by reference herein.

### BACKGROUND

### 1. Technical Field

The present invention relates to a method for manufacturing a three-dimensional object.

### 2. Related Art

Hitherto, various methods for manufacturing three-dimensional objects have been used. Among these is a method for manufacturing a three-dimensional object by sintering a green body.

For example, JP-A-2010-229476 (hereinafter referred to as Patent Document 1) discloses a metalworking process (a method for manufacturing a three-dimensional object) in which a concave portion is formed in an unsintered green body by pressing because the sintered body has low workability, followed by sintering.

However, in a known method for manufacturing a three-dimensional object by sintering a green body as disclosed in Patent Document 1, there is a problem in that, in the case of manufacturing a thick three-dimensional object, gas derived from a binder cannot be released outside in a degreasing or sintering step. Therefore, for example, JP-A-2007-70655 (hereinafter referred to as Patent Document 2) discloses that, in the case of manufacturing a three-dimensional object, regions with low sintering density are distributed or a degassing hole is formed in a base for the purpose of releasing gas outside. However, even if a known method for releasing gas is used as disclosed in Patent Document 2, there is a problem in that gas cannot be sufficiently released outside depending on the thickness of a manufactured three-dimensional object and there is a problem in that a manufactured three-dimensional object has reduced strength.

### SUMMARY

An advantage of some aspects of the invention is that a method for manufacturing a three-dimensional object by sintering a green body is provided. In the method, the three-dimensional object is manufactured without thickness limitations so as to have high strength.

In order to solve the about problems, a method for manufacturing a three-dimensional object according to an aspect of the invention includes a forming step of forming layers using a flowable composition containing a constituent material powder and binder for forming a three-dimensional object; a degreasing step of removing the binder from a multilayer body, formed by stacking the layers, for the three-dimensional object; and a sintering step of sintering the constituent material powder by heating the multilayer body free from the binder. In the layer-forming step, channels leading to a surface of the multilayer body are formed such that gas, derived from the binder, generated in the degreasing step can flow through the channels.

According to the method, in the layer-forming step, the channels are formed such that gas, derived from the binder, generated in the degreasing step can flow through the channels. The channels lead to a surface of the multilayer body. Therefore, forming the channels in, for example, a thick portion enables gas to be effectively released outside the multilayer body through the channels. Furthermore, forming the channels in only a thick portion with high strength (a portion where gas is unlikely to be released) enables an overall reduction in strength to be suppressed. Thus, the three-dimensional object can be manufactured without thickness limitations so as to have high strength.

In the method, the channels are blocked at the end of the sintering step by the contraction of the multilayer body in the sintering step.

According to the method, since the channels are blocked at the end of the sintering step by the contraction of the multilayer body in the sintering step, the reduction in strength of the three-dimensional object can be effectively suppressed.

The method further includes a decision step of deciding whether the channels are formed in the layer-forming step. In the decision step, if there is a thick portion having a region from which the distance to a surface of the multilayer body is not less than a predetermined distance, then it is decided to form the channels in the thick portion.

According to the method, when there is the thick portion, which has the region from which the distance to a surface of the multilayer body is not less than a predetermined distance, the channels are formed in the thick portion. Therefore, when the three-dimensional object has no thick portion or no portion where gas is unlikely to be released, the reduction in strength of the three-dimensional object can be suppressed by forming the channels.

In the method, the predetermined distance is 10 mm.

In general, when the distance to a surface of the multilayer body is greater than 10 mm, gas is unlikely to be released. However, according to the method, when there is a thick portion having a region from which the distance to a surface of the multilayer body is not less than 10 mm, the channels are formed in the thick portion. Therefore, when there is a portion where gas is unlikely to be released, gas can be released from the portion where gas is unlikely to be released.

In the method, the layers are formed in the layer-forming step in such a manner that the flowable composition is linearly extruded and lines formed by linearly extruding the flowable composition are arranged.

According to the method, the layers are formed in the layer-forming step in such a manner that the flowable composition is linearly extruded and the lines formed by linearly extruding the flowable composition are arranged. Thus, the layers can be readily formed by arranging the lines formed by linearly extruding the flowable composition.

In the method, the extrusion width of the linearly extruded flowable composition is 20 mm or less.

According to the method, since the extrusion width of the linearly extruded flowable composition is 20 mm or less, the three-dimensional object can be manufactured so as to be dense.

In the method, in the layer-forming step, the channels are formed by varying the cross-sectional shape of the lines.

According to the method, in the layer-forming step, the channels are formed by varying the cross-sectional shape of the lines. Therefore, the channels can be readily formed by varying the cross-sectional shape of the lines so as to lead to a surface of the multilayer body.

In the method, the channels are formed at intervals of not greater than 20 mm.

Gas is unlikely to be released from a region from which the distance to a location, such as a surface of the multilayer body capable of diffusing gas is greater than 10 mm. According to the method, since the channels are formed at intervals of not greater than 20 mm, a region from which the distance to a location capable of diffusing gas is greater than 10 mm can be eliminated, thereby enabling gas to be effectively released.

In the method, the channels have an inside diameter of 1 μm to 500 μm.

When the inside diameter of the channels is less than 1 the effect of releasing gas is insufficient in some cases. When the inside diameter of the channels is greater than 500 the three-dimensional object has reduced strength in some cases. However, according to the method, since the channels have an inside diameter of 1 to 500 μm, gas can be effectively released outside the multilayer body and a reduction in strength can be suppressed.

In the method, the inside diameter of the channels increases toward a surface of the multilayer body.

According to the method, since the inside diameter of the channels increases toward a surface (the outside) of the multilayer body, gas can be effectively released outside the multilayer body.

The method further includes a support layer-forming step of forming a support layer supporting the multilayer body. In the support layer-forming step, a discharge passage for discharging the gas is formed so as to lead to the outside of the support layer from the channels on a surface of the multilayer body.

According to the method, since the support layer is formed, the multilayer body for the three-dimensional object can be formed so as to have various shapes. Since the discharge passage for discharging the gas is formed in the support layer so as to lead to the outside of the support layer from the channels on a surface of the multilayer body, gas can be effectively released outside the multilayer body, even though the support layer is formed.

In the method, the inside diameter of the discharge passage is greater than or equal to the inside diameter of the channels.

According to the method, the inside diameter of the discharge passage is greater than or equal to the inside diameter of the channels. That is, the inside diameter of the discharge passage increases outwardly. Therefore, gas can be effectively released outside the multilayer body.

In the method, the channels split in a direction from a surface of the multilayer body toward the inside thereof.

According to the method, since the channels split in the direction from a surface of the multilayer body toward the inside thereof, the channels can be densely arranged and gas can be effectively released a portion where gas is unlikely to be released.

### BRIEF DESCRIPTION OF THE DRAWINGS

The invention will be described with reference to the accompanying drawings, wherein like numbers reference like elements.

FIG. 1 is a schematic view showing the configuration of a three-dimensional object-manufacturing apparatus according to an embodiment of the invention.

FIG. 2 is a schematic plan view of an example of a green body formed using the three-dimensional object-manufacturing apparatus shown in FIG. 1.

FIG. 3 is a schematic side view of the green body shown in FIG. 2.

FIG. 4 is a schematic side view of an example of a green body.

FIG. 5 is a schematic side view of an example of a green body.

FIG. 6 is a schematic side view of an example of a green body.

FIG. 7 is a schematic plan view of an example of a green body which is being formed using the three-dimensional object-manufacturing apparatus shown in FIG. 1.

FIG. 8 is a schematic side view of the green body shown in FIG. 7.

FIG. 9 is a schematic side view of an example of a green body.

FIG. 10 is a flowchart showing a method for manufacturing a three-dimensional object according to an embodiment of the invention.

FIG. 11 is a flowchart showing a step of forming a layer in a method for manufacturing a three-dimensional object according to an embodiment of the invention.

### DESCRIPTION OF EXEMPLARY EMBODIMENTS

Embodiments of the invention will now be described with reference to the accompanying drawings.

First, a three-dimensional object-manufacturing apparatus 1 according to an embodiment of the invention is outlined.

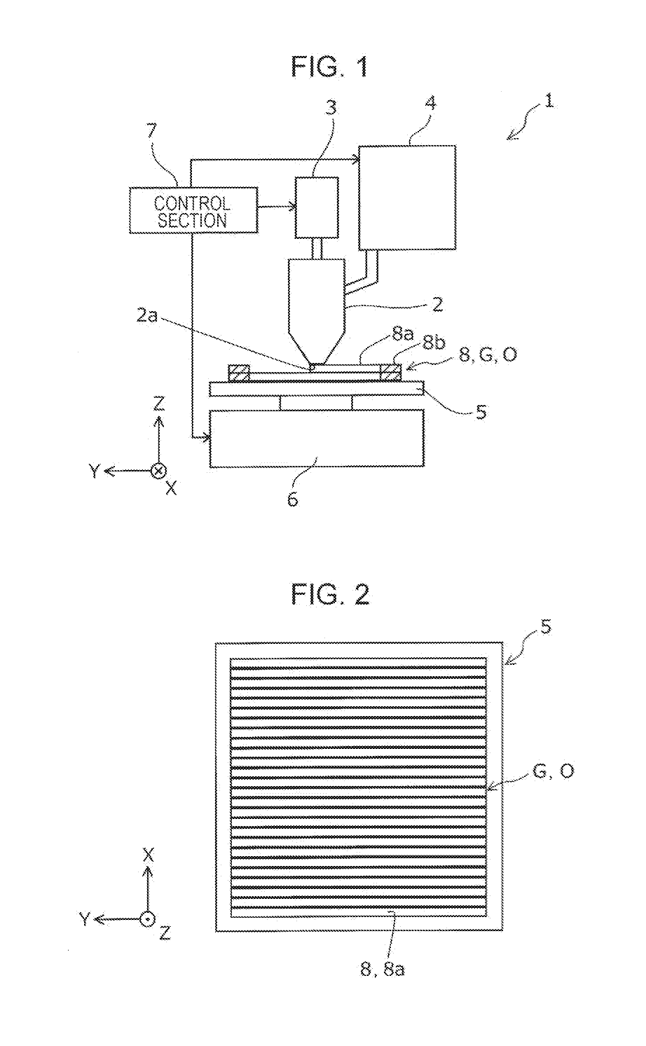

FIG. 1 is a schematic view showing the configuration of the three-dimensional object-manufacturing apparatus 1.

The term “three-dimensional modeling” as used herein refers to forming a so-called stereoscopic object and includes forming a thick shape even if the shape is a tabular shape or a so-called two-dimensional shape (for example, a shape composed of a single layer). The term “support” as used herein includes upward supporting and laterally supporting and also includes downward supporting in some cases.

The three-dimensional object-manufacturing apparatus 1 has such a configuration that a three-dimensional object O can be formed using a constituent material for the three-dimensional object O and a support layer-forming material for forming a support layer supporting a multilayer body (a green body G) for the three-dimensional object O. However, the three-dimensional object-manufacturing apparatus 1 may have such a configuration that the three-dimensional object O is formed without using any support layer-forming material (without forming a support layer 8b), though a formable shape or the like is limited in some cases.

As shown in FIG. 1, the three-dimensional object-manufacturing apparatus 1 can form a constituent layer 8a making up the multilayer body (the green body G) for the three-dimensional object O using a kneaded product (flowable material) containing a constituent material powder and binder for forming the three-dimensional object O. Furthermore, the three-dimensional object-manufacturing apparatus 1 can form the support layer 8b, which supports the green body G, using a kneaded product (flowable material) containing a support layer-forming powder and the binder. In the three-dimensional object-manufacturing apparatus 1, the constituent material (flowable material) and the support layer-forming material (flowable material) are used. The constituent material contains the constituent material powder and the binder, which is solid at room temperature, at a ratio of about 1:1 and becomes flowable by heating during extrusion. The support layer-forming material contains the support layer-forming powder and the binder, which is solid at room temperature, and becomes flowable by melting the binder by heating during extrusion. However, the invention is not limited to any three-dimensional object-manufacturing apparatus using such flowable materials. For example, the following configuration may be used: a configuration in which a flowable material that contains the constituent material powder, a solvent, and a binder soluble in the solvent and that is liquid at room temperature or a flowable material that contains the support layer-forming powder, a solvent, and a binder soluble in the solvent and that is liquid at room temperature is used and is extruded without heating. Therefore, the term “flowable material” includes materials which are flowable during extrusion and which are non-flowable during operation other than extrusion.

The three-dimensional object-manufacturing apparatus 1 includes a stage 5 that can be moved in an X-direction, a Y-direction, and a Z-direction in FIG. 1 or that can be driven in the direction of rotation about a Z-axis. The stage 5 is connected to a stage-driving section 6 electrically connected to a control section 7. The stage 5 is moved by the control if the control section 7 because of such a configuration.

The X-direction is a horizontal direction, the Y-direction is a horizontal direction perpendicular to the X-direction, and the Z-direction is a vertical direction.

The three-dimensional object-manufacturing apparatus 1 includes an ejection section 2 linearly extruding a flowable composition that is the constituent material, which is used to form the constituent layer 8a. The ejection section 2 is supplied with the constituent material from a material supply section 4 and is driven by the driving of a driving section 3 to extrude the flowable composition on the stage 5. The material supply section 4 and the driving section 3 are both electrically connected to the control section 7. The control of the control section 7 allows the constituent material to be supplied to the ejection section 2 from the material supply section 4 and allows the flowable composition to be extruded. The ejection section 2 includes a nozzle 2a provided with a shutter, which is not shown, such that the cross-sectional shape of the linearly extruded flowable composition can be varied. In the three-dimensional object-manufacturing apparatus 1, the nozzle 2a has a circular ejection port and the shutter can cover half of the circular ejection port (make the circular ejection port semicircular).

The three-dimensional object-manufacturing apparatus 1 also includes another ejection section, which is not shown in FIG. 1, linearly extruding a flowable composition that is the support layer-forming material, which is used to form the support layer 8b. This ejection section has substantially the same configuration as that of the ejection section 2, which is used to form the constituent layer 8a.

Three-dimensional modeling pastes each of which is used as a corresponding one of the constituent material and the support layer-forming material are described below in detail.

As the constituent material powder of the constituent material and the support layer-forming powder of the support layer-forming material, the following powder can be used: for example, a powder of magnesium (Mg), iron (Fe), cobalt (Co), chromium (Cr), aluminium (Al), titanium (Ti), copper (Cu), or nickel (Ni); a powder of an alloy, such as maraging steel, stainless steel, cobalt-chromium-molybdenum, a titanium alloy, a nickel alloy, permalloy, an aluminium alloy, a cobalt alloy, or a cobalt-chromium alloy, containing one or more of magnesium, iron, cobalt, chromium, aluminium, titanium, copper, and nickel; or the like.

Furthermore, a general-purpose engineering plastic such as polyamide, polyacetal, polycarbonate, modified polyphenylene ether, polybutylene terephthalate, or polyethylene terephthalate can be used. In addition, an engineering plastic (resin) such as polysulfone, polyethersulfone, polyphenylene sulfide, polyallylate, polyimide, polyamideimide, polyetherimide, or polyether ether ketone can be used.

The constituent material powder and the support layer-forming powder are not particularly limited. Metal other than the above metals, ceramic, resin, or the like can be used. Silicon dioxide (SiO₂), titanium dioxide (TiO₂), aluminium oxide (Al₂O₃), zirconium oxide (ZrO), or the like can be used.

Examples of the binder include various resins such as polyolefins including polyethylene, polypropylene, and an ethylene-vinyl acetate copolymer; acrylic resins including polymethyl methacrylate and polybutyl methacrylate; styrenic resins including polystyrene; polyvinyl chloride; polyvinylidene chloride; polyamide; polyesters including polyethylene terephthalate and polybutylene terephthalate; polyether; polyvinyl alcohol; polyvinylpyrrolidone; and copolymers of these polymers and also include various waxes and various organic binders such as paraffins, higher fatty acids including stearic acid, higher alcohols, higher fatty acid esters, and higher fatty acid amides. These compounds can be used alone or in combination.

The content of the binder in each kneaded product is preferably about 2% to 20% by mass and more preferably about 5% to 10% by mass. When the content of the binder is within the above range, a layer can be formed with good formability and the green body G can have increased density, particularly excellent shape stability, and the like. This enables the difference in size between the green body G and a degreased body, that is, the shrinkage to be optimized, thereby enabling the reduction in dimensional accuracy of a finally obtained sintered body to be prevented. That is, a sintered body having high density and high dimensional accuracy can be obtained.

The kneaded product may contain a plasticizer as required. Examples of the plasticizer include phthalates such as dioctyl phthalate (DOP), diethyl phthalate (DEP), and dibutyl phthalate (DBP); adipates; trimellitates; and sebacates. These compounds may be used alone or in combination.

The kneaded product may further contain, for example, various additives such as a lubricant, an oxidation inhibitor, a degreasing aid, and a surfactant as required in addition to the constituent material powder, the support layer-forming powder, the binder, and the plasticizer.

Examples of the solvent include water; (poly)alkylene glycol monoalkyl ethers such as ethylene glycol monomethyl ether, ethylene glycol monoethyl ether, propylene glycol monomethyl ether, and propylene glycol monoethyl ether; acetates such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl n-butyl ketone, diisopropyl ketone, and acetyl acetone; alcohols such as ethanol, propanol, and butanol; tetraalkylammonium acetates; sulfoxide solvents such as dimethyl sulfoxide and diethyl sulfoxide; pyridine solvents such as pyridine, γ-picoline, and 2,6-lutidine; and ionic liquids such as tetraalkylammonium acetates including tetrabutylammonium acetate. One or more selected from these compounds can be used in combination.

An example of forming the three-dimensional object O (the green body G) using the three-dimensional object-manufacturing apparatus 1 is described below.

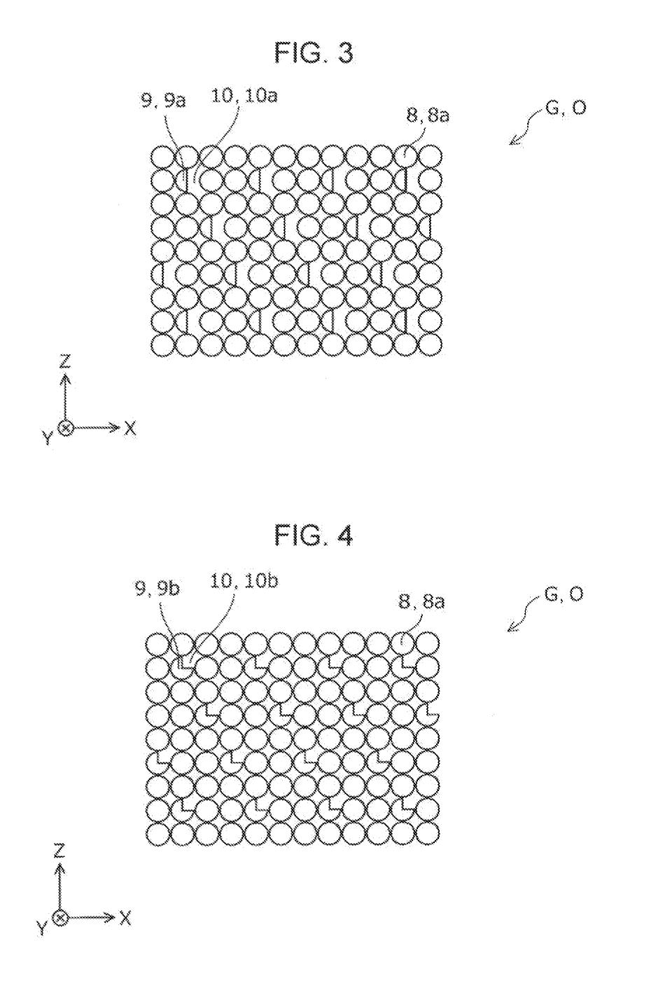

FIG. 2 is a schematic plan view of an example of the green body G, which is formed using the three-dimensional object-manufacturing apparatus 1. FIG. 3 is a schematic side view of the green body G shown in FIG. 2.

FIGS. 4 to 6 are schematic side views of other examples different from the example of the green body G that is shown in FIG. 3.

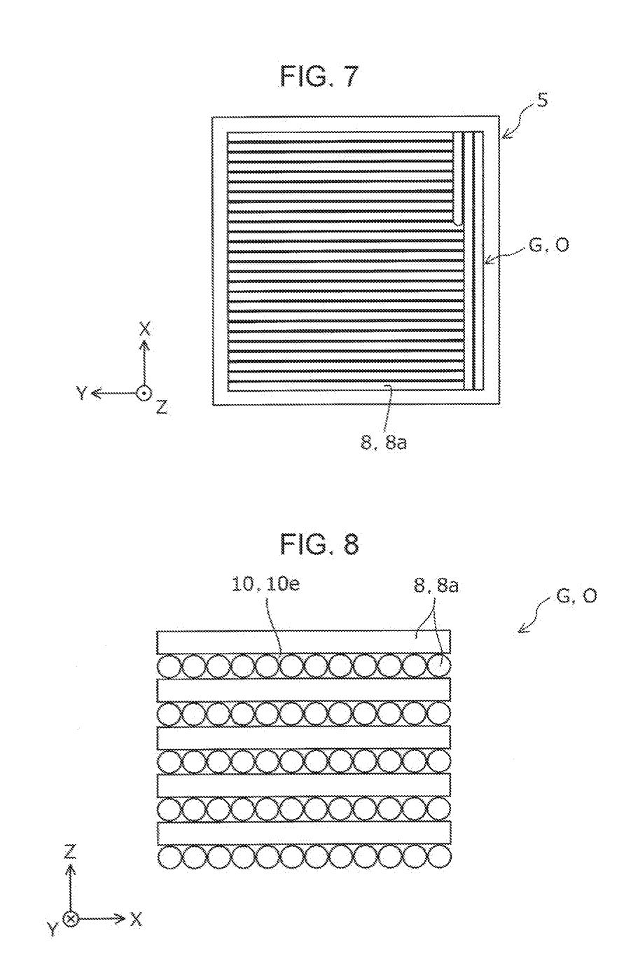

FIG. 7 is a schematic plan view of an example of the green body G which is being formed using the three-dimensional object-manufacturing apparatus 1. FIG. 8 is a schematic side view of the green body G shown in FIG. 7.

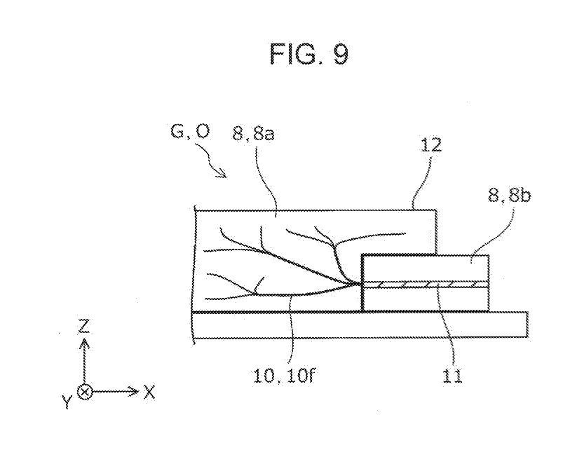

FIG. 9 is a schematic side view of another example of the green body G.

As shown in FIG. 2, the three-dimensional object-manufacturing apparatus 1 continuously extrudes the flowable composition on the stage 5 and therefore can linearly extrude the flowable composition in the Y-direction. A layer 8 can be formed in such a manner that lines formed by linearly extruding the flowable composition are arranged in the X-direction. FIG. 2 shows such a state that the formed layer 8 is the constituent layer 8a. The case where the formed layer 8 is the support layer 8b results in substantially the same state as the state shown in FIG. 2 (a state that the lines formed by linearly extruding the flowable composition are arranged).

The three-dimensional object-manufacturing apparatus 1 forms another layer 8 on the stage 5 or the already formed layer 8 (lower layer) in such a manner that the extruded flowable composition is stacked while being pressed against the stage 5 or the lower layer. Therefore, though the ejection port of the nozzle 2a of the ejection section 2 is circular, the cross section of the linearly extruded flowable composition (on the stage 5) is actually flat and substantially no gap is present between the neighboring lines. Incidentally, in order to readily grasp the layer structure of the formed green body G, FIGS. 4, 5, 6, and 8 show that the cross-sectional shape of lines making up each layer 8 are circular.

As described above, the three-dimensional object-manufacturing apparatus 1 includes the shutter, which can cover half of the circular ejection port. As shown in FIG. 3, when a thick portion of the green body G is formed, a portion (half) of the nozzle 2a is covered with the shutter at predetermined intervals, whereby low extrusion portions 9 (low extrusion portions 9a) with a small injection capacity are formed in the Y-direction. Forming the low extrusion portions 9 (low extrusion portions 9a) allows gaps extending in the Y-direction to be formed. The gaps form channels 10 (channels 10a) leading to a surface of the green body G (an end surface in the Y-direction). The channels 10 are passages for discharging gas, derived from the binder, generated by degreasing the green body G outside.

In an example of the green body G formed as shown in FIG. 3, the low extrusion portions 9 and the channels 10 are formed using the shutter, which can cover half of the circular ejection port of the nozzle 2a. The low extrusion portions 9 and the channels 10 are not limited to such an example. Low extrusion portions 9b and channels 10b may be formed as shown in FIG. 4 by varying, for example, the shape of the shutter.

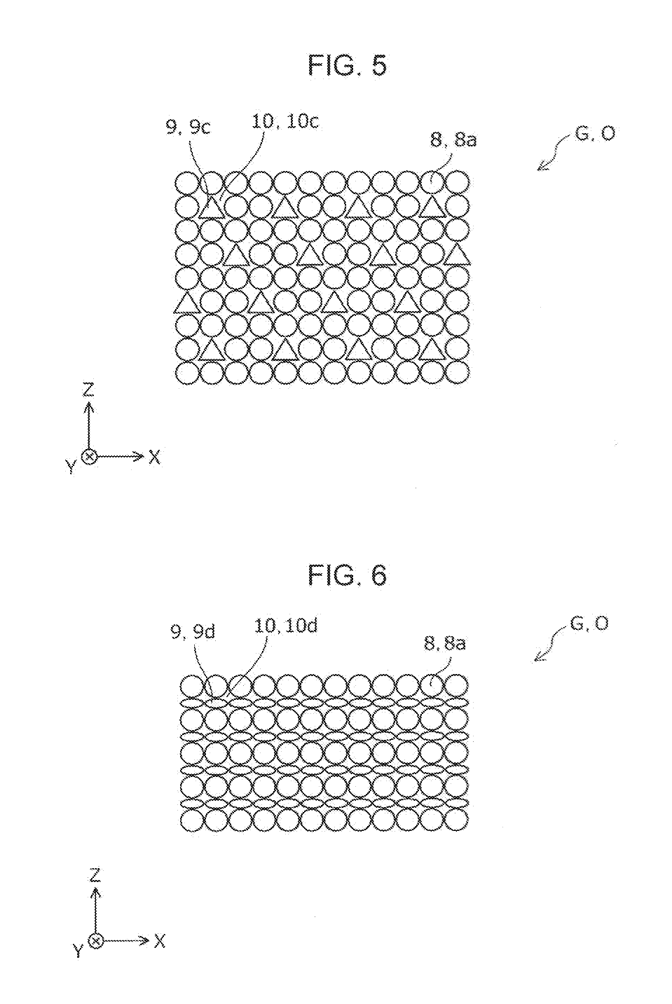

Forming the low extrusion portions 9 and the channels 10 using the shutter is not particularly limited. Low extrusion portions 9c and channels 10c may be formed using, for example, a nozzle having a triangular ejection port in addition to the nozzle 2a, which has the circular ejection port, as shown in FIG. 5. Low extrusion portions 9d and channels 10d may be formed using, for example, a nozzle having an oval ejection port in addition to the nozzle 2a, which has the circular ejection port, as shown in FIG. 6. Alternatively, the low extrusion portions 9 and the channels 10 may be formed using nozzles having ejection ports with different shapes.

The low extrusion portions 9 and the channels 10 may be formed using, for example, only a nozzle having an ejection port with a single type of shape in such a manner that some of the lines are narrowed by adjusting the injection capacity of the flowable composition per unit time or by adjusting the movement speed of the nozzle relative to the stage 5.

Alternatively, the channels 10 may be formed by varying the arrangement of lines of the flowable composition without forming the low extrusion portions 9.

As shown in FIG. 7, the three-dimensional object-manufacturing apparatus 1 can arrange lines of the flowable composition, linearly extruded in the Y-direction, in the X-direction and can also arrange lines of the flowable composition, linearly extruded in the X-direction, in the Y-direction. For example, the arrangement of lines may be varied every time each layer 8 is stacked as shown in FIG. 8. In the case of forming the layers 8 as described above, gaps are formed between the layers 8 and the gaps form the channels 10. In an example of the green body G formed as shown in FIG. 8, the channels 10 (channels 10e) are formed so as to extend in the Y-direction and the X-direction in a double-cross formation.

In another example, the channels 10 may be formed in such a manner that grooves are formed by bringing protrusions (for example, a pinholder) into contact with a surface portion of each layer 8 in the X-direction and the Y-direction every time the layer 8 is formed. Incidentally, the three-dimensional object-manufacturing apparatus 1 preferably has such a configuration that protrusions or the like need not be placed (such a configuration that the channels 10 are formed by controlling the extrusion of the flowable composition).

In examples of the green body G formed as shown in FIGS. 2 to 8, the channels 10 are formed in parallel to the layers 8. The channels 10 are not limited to such examples. The channels 10 may be formed so as not to be parallel to the layers 8 in such a manner that cavity portions in which no flowable composition is placed are formed in each layer 8 so as to overlap each other between the layers 8 neighboring in a stacking direction (the Z-direction).

FIG. 9 shows an example of the green body G provided with channels 10 (channels 10f) not parallel to the layers 8. As shown in FIG. 9, the channels 10f extend not only in a direction (a horizontal direction) parallel to the layers 8 but also in the stacking direction (the Z-direction). The channels 10f include portions which are in contact with the support layer 8b and which are connected to the outside of the green body G. The support layer 8b is provided with a discharge passage 11 such that gas can be discharged outside the green body G from the channels 10f.

An example of a method for manufacturing the three-dimensional object O using the three-dimensional object-manufacturing apparatus 1 is described below using flowcharts.

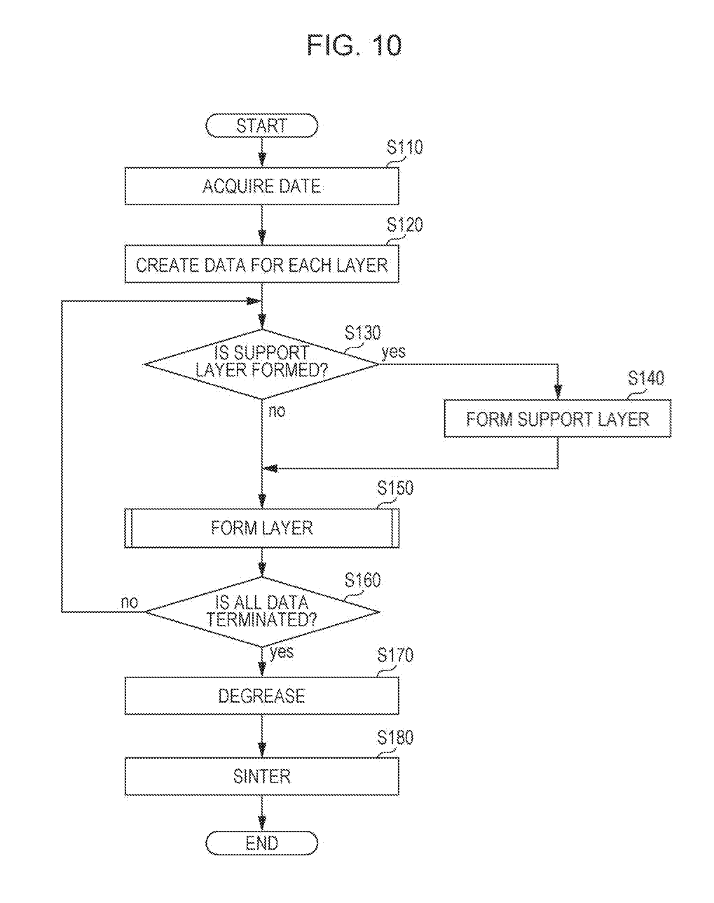

FIG. 10 is a flowchart showing an example of the method for manufacturing the three-dimensional object O.

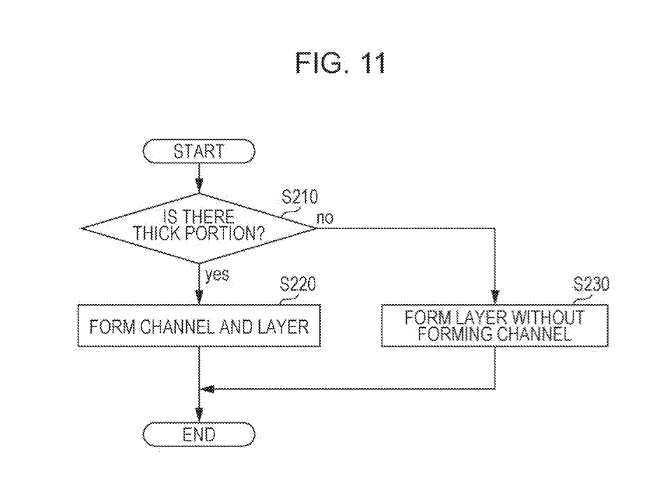

FIG. 11 is a flowchart showing a layer-forming step of the method for manufacturing the three-dimensional object O.

As shown in FIG. 10, in the method for manufacturing the three-dimensional object O, first, data on the three-dimensional object O is acquired in Step S110. In particular, data on the shape of the three-dimensional object O is acquired from, for example, an application program executed on a personal computer or the like.

Next, in Step S120, data is created (generated) for each layer by the control of the control section 7. In particular, the data on the shape of the three-dimensional object O is sliced in accordance with modeling resolution in the Z-direction, whereby bit map data is generated for each cross section.

Next, in Step S130, whether the support layer 8b is formed is decided. In particular, as shown in FIG. 9, a decision is made depending on whether there is an undercut portion 12 that may possibly be deformed by the influence of gravity in the case where the constituent layer 8a is not upwardly support by the support layer 8b. If it is decided to form the support layer 8b, then Step S140, that is, a support layer-forming step is performed such that the support layer 8b is formed, followed by Step S150. In Step S140, the support layer 8b is formed so as to be provided with the discharge passage 11 as required. However, if it is decided not to form the support layer 8b, then the method proceeds to Step S150 without performing Step S140.

In Step S150, that is, a layer-forming step, the flowable composition (the constituent material) is ejected from the ejection section 2 by the control of the control section 7 on the basis of the bit map data generated in Step S120, whereby each layer 8 (constituent layer 8a) is formed on the basis of the bit map data.

Step S150, that is, the layer-forming step is described in detail with reference to FIG. 11.

As shown in FIG. 11, after Step S150, that is, the layer-forming step starts, first, whether the channels 10 are formed is decided in Step S210, that is, a decision step by the control of the control section 7. This decision is made depending on whether there is a thick portion having a region from which the distance to a surface of the green body G, which is the multilayer body for the three-dimensional object O, is not less than a predetermined distance (in this embodiment, 10 mm). In other words, in the case of forming the green body G, whether there is a region from which the distance to a surface of the green body G is not less than 10 mm in all of the X-, Y-, and Z-directions in a portion is decided on the basis of bit map data on a plurality of neighboring layers. If it is decided that there is such a region, then the method proceeds to Step S220. If it is decided that there is not such a region, then the method proceeds to Step S230.

In Step S220 (in the case where there is the thick portion), the layer 8 (constituent layer 8a) is formed in such a manner that the channels 10 are provided in a location corresponding to the thick portion such that the distance from every region in the location to a surface of the green body G or to the nearest channel 10 is 10 mm or less. However, in a location not corresponding to the thick portion, the layer 8 (constituent layer 8a) is formed without forming the channels 10.

In Step S230 (in the case where there is no thick portion), the layer 8 (constituent layer 8a) is formed without forming the channels 10.

Step S150, that is, the layer-forming step is completed together with the completion of Step S220 or Step S230 (in FIG. 10, the method proceeds to Step S160).

In Step S160, whether the formation of the layer 8 on the basis of the bit map data generated in Step S120 is completed by the control of the control section 7 is decided. If it is decided that the formation of the layer 8 has not been completed, then the method returns to Step S130. If it is decided that the formation of the layer 8 has been completed, then the method proceeds to Step S170. That is, Steps S130 to S160 are repeated until the formation of the green body G on the basis of the bit map data, generated in Step S120, corresponding to each layer 8 is completed by the control of the control section 7.

Next, in Step S170, that is, a degreasing step, the green body G formed through the above steps is degreased (the binder is removed from the constituent layer 8a) by heating in, for example, a thermostatic bath, which is not shown. The degreasing converts the green body G into a brown body.

In Step S180, that is, a sintering step, the brown body formed in the above step is heated in, for example, a thermostatic oven, which is not shown, whereby the constituent material powder in the constituent layer 8a is sintered.

Step S180, that is, the sintering step is completed, whereby the method for manufacturing the three-dimensional object O is completed.

As described above, the method for manufacturing the three-dimensional object O includes the layer-forming step (Step S150) of forming the layers 8 using the flowable composition containing the constituent material powder and binder for forming the three-dimensional object O, the degreasing step (Step S170) of removing the binder from the multilayer body (green body G), formed by stacking the layers 8, for the three-dimensional object O, and the sintering step (Step S180) of sintering the constituent material powder by heating the multilayer body free from the binder. In the layer-forming step, the channels 10 (the channels 10, which lead to a surface of the green body G) can be formed by controlling the extrusion of the flowable composition such that gas, derived from the binder, generated in the degreasing step or the sintering step can flow through the channels 10 (Step S220). Therefore, forming the channels 10 in, for example, the thick portion enables gas to be effectively released outside the green body G through the channels 10. Furthermore, forming the channels 10 in a high-strength thick portion (a portion where gas is unlikely to be released) only enables an overall reduction in strength to be suppressed. Thus, according to the method for manufacturing the three-dimensional object O, the three-dimensional object O can be manufactured without thickness limitations so as to have high strength. Effectively releasing gas outside the green body G facilitates sintering and therefore enables the sintering time of a large-size object to be reduced.

The channels 10 are preferably blocked at the end of the sintering step by the contraction of the multilayer body for the three-dimensional object O in the sintering step. This is because blocking (disabling) the channels 10 enables the reduction in strength of the three-dimensional object O to be particularly effectively suppressed.

The channels 10 preferably have an inside diameter of 1 μm to 500 μm.

When the inside diameter of the channels 10 is less than 1 the effect of releasing gas is insufficient in some cases. When the inside diameter of the channels 10 is greater than 500 the channels 10 are not blocked and the three-dimensional object O has reduced strength in some cases.

Since the channels 10 are not necessarily circular in cross section, the inside diameter of the channels 10 can be defined as, for example, the maximum size of the inside of the channels 10.

The channels 10 are preferably configured such that the inside diameter thereof increases toward a surface of the green body G. This is because gas can be particularly effectively released outside the green body G.

The phrase “the inside diameter increases toward a surface” as used herein means not only that the inside diameter gradually increases toward a surface of the green body G but also that, overall, the inside diameter tends to increase toward a surface of the green body G and also means that, overall, the inside diameter tends to increase toward a surface of the green body G even if there is, for example, a portion where the inside diameter partly decreases toward a surface of the green body G.

As described above, the method for manufacturing the three-dimensional object O includes the decision step (Step S210) of deciding whether the channels 10 are formed in the layer-forming step. In the decision step, if there is a thick portion having a region from which the distance to a surface of the green body G is not less than a predetermined distance, then it is decided to form the channels 10 in the thick portion. Therefore, according to method for manufacturing the three-dimensional object O, when the three-dimensional object O has no thick portion or no portion where gas is unlikely to be released, the reduction in strength of the three-dimensional object O can be suppressed by forming the channels 10.

The predetermined distance is 10 mm.

In general, when the distance to a surface of the green body G is greater than 10 mm, gas is unlikely to be released. However, in the method for manufacturing the three-dimensional object O, when there is a thick portion having a region from which the distance to a surface of the green body G is not less than 10 mm, the channels 10 are formed in the thick portion. Therefore, according to the method for manufacturing the three-dimensional object O, even if there is a portion where gas is unlikely to be released, gas can be effectively released from the portion where gas is unlikely to be released.

In the method for manufacturing the three-dimensional object O, the layers 8 are formed in the layer-forming step in such a manner that the flowable composition is linearly extruded and the lines formed by linearly extruding the flowable composition are arranged as shown in FIGS. 2 and 7. Thus, a layer can be readily formed by arranging the lines formed by linearly extruding the flowable composition.

The extrusion width of the linearly extruded flowable composition is preferably 20 mm or less. This is because setting the extrusion width to 20 mm or less enables dense three-dimensional objects to be manufactured.

In the method for manufacturing the three-dimensional object O, the channels 10 can be formed in such a manner that the cross-sectional shape of the lines is varied (a circular shape is converted into a semicircular shape) in the layer-forming step as shown in FIG. 3. Therefore, the channels 10 can be readily formed by varying the cross-sectional shape of the lines so as to lead to a surface of the green body G.

A method for varying the cross-sectional shape of the lines is not particularly limited and the following measures may be taken: using a shutter partly blocking a nozzle, using ejection sections having different nozzle shapes (a triangular shape, an oval shape, or the like) as described above, varying the injection capacity of the flowable composition per unit time (for example, reducing the injection capacity thereof), varying the movement speed of the ejection section 2 relative to the stage 5 (for example, increasing the movement speed of the stage 5), and the like.

As described above, in the method for manufacturing the three-dimensional object O, the layers 8 are formed in such a manner that the channels 10 are arranged such that the distance to a surface of the green body G or to the nearest channel 10 is 10 mm or less.

In other words, the channels 10 are formed at intervals of not greater than 20 mm.

Gas is unlikely to be released from a region from which the distance to a location, such as a surface of the green body G, capable of diffusing gas is greater than 10 mm. According to the method for manufacturing the three-dimensional object O, the channels 10 are formed at intervals of not greater than 20 mm and therefore such a region from which the distance to a location capable of diffusing gas is greater than 10 mm can be eliminated, thereby enabling gas to be effectively released.

The method for manufacturing the three-dimensional object O includes the support layer-forming step (Step S140) of forming the support layer 8b, which supports the constituent layer 8a of the green body G. In the support layer-forming step, the discharge passage 11 for gas is formed so as to lead to the outside of the support layer 8b from the channels 10 on a surface of the green body G as shown in FIG. 9.

Since the support layer 8b is formed, the green body G can be formed so as to have various shapes. Since the discharge passage 11 for gas is formed in the support layer 8b so as to lead to the outside of the support layer 8b from the channels 10 on a surface of the green body G, gas can be effectively released outside the green body G, even though the support layer 8b is formed.

The inside diameter of the discharge passage 11 is preferably greater than or equal to the inside diameter of the channels 10. This is because a configuration in which the inside diameter increases outward enables gas to be effectively released outside the green body G.

The phrase “the inside diameter of the discharge passage 11 is greater than or equal to the inside diameter of the channels 10” as used herein means that the average inside diameter of the discharge passage 11 may be greater than or equal to the average inside diameter of the channels 10. This means that a configuration in which the average inside diameter of the discharge passage 11 is greater than or equal to the average inside diameter of the channels 10 even if the discharge passage 11 has a portion with an inside diameter less than that of the channels 10 is included.

As shown in FIG. 9, the channels 10 are preferably formed so as to split in a direction from a surface of the green body G toward the inside thereof. This is because forming the channels 10 as described above enables the channels 10 to be densely arranged and therefore enables gas to be effectively released from a portion where gas is unlikely to be released.

The invention is not limited to the above-mentioned embodiments and can be embodied in various configurations without departing from the spirit of the invention. For example, degreasing and sintering may be performed together (degreasing and sintering may be performed in one step) in such a manner that the green body G is placed in a vacuum degreasing sintering furnace.

Technical features in the embodiments that correspond to those in the aspects described in Summary may be appropriately replaced or combined in order to solve some or all of the problems described above or in order to achieve some or all of the advantageous effects described above. The technical features may be appropriately omitted unless the technical features are described as essential herein.

What is claimed is:

1. A method for manufacturing a three-dimensional object, comprising:
forming layers using a flowable composition containing a constituent material powder and binder for forming a three-dimensional object;
performing degreasing to remove the binder from a multilayer body, formed by stacking the layers, for the three-dimensional object; and
sintering the constituent material powder by heating the multilayer body free from the binder,
wherein in the course of forming the layers, channels leading to a surface of the multilayer body are formed such that gas, derived from the binder, generated by degreasing can flow through the channels.

2. The method for manufacturing the three-dimensional object according to claim 1, wherein the channels are blocked at the end of sintering by the contraction of the multilayer body due to sintering.

3. The method for manufacturing the three-dimensional object according to claim 1, further comprising deciding whether the channels are formed in the course of forming the layers, wherein if there is a thick portion having a region from which the distance to a surface of the multilayer body is not less than a predetermined distance, then it is decided to form the channels in the thick portion.

4. The method for manufacturing the three-dimensional object according to claim 3, wherein the predetermined distance is 10 mm.

5. The method for manufacturing the three-dimensional object according to claim 1, wherein the layers are formed in such a manner that the flowable composition is linearly extruded and lines formed by linearly extruding the flowable composition are arranged.

6. The method for manufacturing the three-dimensional object according to claim 5, wherein the extrusion width of the linearly extruded flowable composition is 20 mm or less.

7. The method for manufacturing the three-dimensional object according to claim 5, wherein in the course of forming the layers, the channels are formed by varying the cross-sectional shape of the lines.

8. The method for manufacturing the three-dimensional object according to claim 1, wherein the channels are formed at intervals of not greater than 20 mm.

9. The method for manufacturing the three-dimensional object according to claim 1, wherein the channels have an inside diameter of 1 μm to 500 μm.

10. The method for manufacturing the three-dimensional object according to claim 1, wherein the inside diameter of the channels increases toward a surface of the multilayer body.

11. The method for manufacturing the three-dimensional object according to claim 1, further comprising forming a support layer supporting the multilayer body, wherein in the course of forming the support layer, a discharge passage for discharging the gas is formed so as to lead to the outside of the support layer from the channels on a surface of the multilayer body.

12. The method for manufacturing the three-dimensional object according to claim 11, wherein the inside diameter of the discharge passage is greater than or equal to the inside diameter of the channels.

13. The method for manufacturing the three-dimensional object according to claim 1, wherein the channels split in a direction from a surface of the multilayer body toward the inside thereof.
